(19) United States
(12) Patent Application Publication
(10) Pub. No.: US 2007/0017255 A1
(43) Pub. Date: Jan. 25, 2007

(54) Method of recycling glass fiber material

(76) Inventor: Erik Grove-Nielsen, Roslev (DK)

Correspondence Address: KNOBBE MARTENS OLSON & BEAR LLP, 2040 MAIN STREET, FOURTEENTH FLOOR, IRVINE, CA, 92614, US

(21) Appl. No.: 10/576,643

(22) PCT Filed: Oct. 22, 2004
(86) PCT No.: PCT/DK04/00729

§ 371 Date: Apr. 21, 2006

(51) Int. Cl. C03B 3/00; C03B 1/00

(52) U.S. Cl. 65/482

(57) ABSTRACT

A method and an apparatus for recycling glass fibre material are disclosed, as well as products fabricated by the disclosed method. The invention deals with mechanically transforming glass fibre material extracted from a composite material in a first form to glass fibre material in a second form. The glass fibre material is further treated into a third form, the glass fibre material is further treated into a third form, the glass fibre material in the third form being suitable for insulation material. The glass fibre in the third form may be such insulation material as wool or cotton-like insulation material, insulation bats, insulation rolls, insulation pellets, insulation panels, such as curved panels and self-sustaining panels.

### FIELD OF THE INVENTION

The present invention relates to a method of recycling glass fibre material, more specifically the present invention relates to a method of recycling glass fibres as glass fibre insulation material, as well as to an apparatus utilising the method and applications of the method.

### BACKGROUND OF THE INVENTION

Fibre reinforced materials are widely used for reinforcements of a variety of materials in a variety of applications, e.g. wind turbine blades. One of the more popular fibre reinforcements is glass fibre. Glass fibre may be extracted for recycling from the carrier material which usually is an epoxy material, a polyester resin or a thermoplastic material.

Attempts have been made to recycle fibre reinforced materials as filling material in plastics and rubbers after appropriate breaking of the material into granulate or powder. However, filling materials of this type are already largely available on the market and, consequently, the demand is limited and the price is low. Moreover, the poorly defined fibre content of the composite materials will be problematic, e.g. when the plastic or rubber is later to be recycled.

Another known application of discarded composite material is use as fuel supplement for large combustion plants, where the high calorific value of the matrix material is utilised in combustion. For this application, breaking into lumps having a dimension of approx. one centimetre is adequate. Even this relatively coarse breaking of the composite material is, however, costly and makes the method unprofitable. Furthermore, the glass fibres' content of very fine glass raw material is lost in this method and cannot be recycled, but results in an undesirable slag product.

Glass fibre is a well-known and commonly used material for insulation. Glass fibre insulation material is usually fabricated using a method where raw glass is first melted in a high temperature furnace at around 1550° C. The liquid glass is then spun using a specially formed metal dish or ‘crown’ at high speed to bring the glass on a fibre form. Subsequently, the glass fibre material is formed into the desired shape of the insulation material by use of a binder agent. The form of the fibre material is e.g. a roll of glass fibre insulation. This method of fabricating glass fibre insulation material does, however, not take the origin of the raw glass into account, especially it does not take into account that the raw glass may originate from already produced glass fibre material.

The inventor of the present invention has appreciated that it would be of benefit to provide a method for recycling the glass fibre content contained in composite materials, and has in consequence devised the present invention.

### SUMMARY OF THE INVENTION

It is an object of the present invention to provide means for recycling glass fibre as glass fibre insulation material, and further to provide means for fabrication of glass fibre insulation material in an energy saving, environmentally safe and cost effective way, which additionally provides a way of dealing with waste problems relating from glass fibre waste.

According to a first aspect of the invention, the above-mentioned and other objects are fulfilled by providing a method of recycling glass fibre material, the method comprising the steps of:
providing glass fibre material extracted from a composite material containing glass fibre embedded in a matrix material, the glass fibre material being provided in a first form,
mechanically treating the glass fibre material in the first form into glass fibre material in a second form, the glass fibres in the second form having a mean fibre length smaller than the mean fibre length of the glass fibres in the first form, and
further treating the glass fibre material in the second form so as to obtain glass fibre material in a third form, the glass fibre material in the third form being suitable for insulation material, i.e. the third form contain glass fibres in a form where the fibres are in a random, or apparently random, network embracing air-cavities.

The glass fibre material may be extracted from a composite material, e.g. a glass fibre reinforced plastic material. The composite material may comprise a thermosetting resin, such as an epoxy material, a polyester resin, a vinylesther resin, and/or a phenoplast resin and/or a thermoplastic material as the matrix material. Such materials may e.g. originate from a wind turbine blade, other parts of a wind turbine, glass fibre boats, etc.

Thus a method is provided where already produced glass fibres may be recycled as an insulation material, and thereby avoiding the step of re-bringing raw glass on fibre form.

This is an energy saving, cost effective and environmentally safer way of producing glass fibre insulation material than producing glass fibre from raw glass. Additionally, glass fibre waste is increasing, e.g. due to scrapping of wind turbines. The present invention provides a method of dealing with waste problems relating from glass fibre waste.

Recycling of the glass fibre content contained in composite materials for e.g. glass or fibre production is attractive due to the high quality and thus relatively high price of the glass material. Recycling of the glass requires that it may be isolated in a chemically and structurally substantially unaltered condition and cleaned of impurities.

Several methods exist of extracting the glass fibres from a composite material. In relation with the present invention it is preferable to extract the glass fibre material in a first form in such a way that the first form is substantially free of matrix material. Additionally, the glass fibres in the first form may be extracted from the matrix material in such a way that the glass fibres are substantially chemically and/or structurally unaltered. Further, the glass fibres may be extracted in a non-brittle form, i.e. in a form where at least 5% of the original tensile strength is maintained, such as at least 10%, such as at least 20%, such as at least 30%, such as at least 40%, such as at least 50%, such as at least 60%, such as at least 70%, such as at least 80%, such as at least 90%, such as approximately 95% of the tensile strength of the glass fibres is maintained. The glass fibre material in the first form may be oriented in any possible way. For example, the glass fibres in the first form may be a fabric, may be oriented as yarn or roving, may be randomly oriented e.g. in a chopped strand mat (CSM) form, etc.

The glass fibre material is mechanically treated into a second form. The treatment may include chopping the fibres so that the mean fibre length in the second form is shorter than the mean fibre length in the first form. The treatment may separate the fibres into single fibres or small clusters or aggregates of fibres, the treatment may also entangle the fibres into a cotton like structure or filament form.

The glass fibre material is further treated to obtain a third form being suitable for insulation material. The exact nature of this third form may depend upon the type of insulation material intended for. For example, the insulation material may be intended for use in insulation of buildings e.g. by providing the insulation material in building cavities, the insulation material may also be intended for use in exhaust silencer on motor vehicles.

The glass fibres in the first form may be in a non-powder form. Thus, the fibres in the first form may have certain minimum length. The length of the fibres in the first form may depend upon from where the glass fibre material was extracted. The length of the fibres in the first form may range from a few tenths of a millimetre to several tenths of centimetres. The fibres in the first form may also have a length up to several metres, e.g. originating from fibres contained in windmill wings, boats, etc. Such large glass fibre product may contain single through-going fibres.

The glass fibre material in the first form may be extracted in different ways. The glass fibre material may be extracted by means of pyrolysis or gasification of the matrix material, by means of incineration or oxygen combustion of the matrix material, by means of chemically dissolving of the matrix material, or by any means possible of releasing the glass fibre from the embedding matrix.

The composite material may be a waste material. The composite material may be a waste material relating to a product which is worn out e.g. at the end of the product life, a new product being scrapped due to production errors, production waste e.g. from the glass fibre industry or other industrial waste.

The glass fibre extracted from the composite material may be mixed with an amount of mineral wool produced in a different process, i.e. an amount of mineral wool may be added to the glass fibre in the first form. The mineral wool produced in a different process may be such mineral wool as standard insulation stone and/or glass wool, e.g. wool of the type fabricated by Rockwool (Stone wool) or Isover (glass wool) or any other type. The added mineral wool may be such wool as waste wool, discarded wool, surplus wool, worn-out wool, recycled wool, etc. The amount of mineral wool that may be added may be as little as a few percent, such as 5 to 10%, in the range 10 to 40%, or even 50% or more, such as 75%.

The mechanical treatment may comprise the steps of passing the glass fibre material from an inlet through a chamber comprising a rotor and a plurality of stators and from the chamber through a mesh or sieve into an outlet. The rotor may be in the form a cylinder rotating with a speed of 400 revolutions/min or any speed appropriate for the mechanical treatment of the glass fibre material. The stators may act as knives cutting up the glass fibre material in the first form.

Different meshes may be utilised. The choice of mesh may depend upon the type of insulation material intended for. Preferably different meshes with different mesh openings may be utilised. The mesh may comprise mesh openings in the size range 1-10 mm, such as 2-8 mm, such 3-5 mm. The mesh may also comprise mesh openings in the size range 20-50 mm, such as 25-45 mm, such as 30-40 mm, such as approximately 35 mm.

The mesh opening size may determine the mean fibre length of the glass fibre material in the second form. Depending upon the size of the mesh openings, the glass fibre material in the second form may comprise glass fibres having a mean fibre length substantially in the range of 0.1-5 mm, such as 0.5-5 mm, such as between 1-4 mm, such as between 2-3 mm. The glass fibre material in the second form may with a different mesh opening size comprise glass fibres having a mean fibre length substantially in the range of 10-40 mm, such as 15-35 mm such as 20-30 mm, such as approximately 25 mm.

The insulation material in the third form may be suitable for heat insulation, cold insulation and/or sound insulation. The glass fibre may e.g. be in the form of glass wool. The glass wool may have a similar or comparable structure as commercial glass wool fabricated from raw glass. The structure may be similar both with respect to chemical composition and with respect to structure of the individual fibrils. However, glass fibre glass used for reinforcement may contain boron which is usually not contained in glass fibre glass fabricated from raw glass not to be used as reinforcements. However, the presence of boron in the glass fibres may be an advantage due to that the temperature to which the glass fibre material fabricated using the method of the present invention may be exposed to may be around 800° C. This temperature may be 200° C. higher than the temperature glass fibre insulation material fabricated from raw glass may be exposed to. Glass fibre glass which do not contain boron may usually be exposed to temperatures up to 600° C.

The glass fibre material in the second form may further be treated into substantially pellet-shaped objects comprising glass fibre and optionally a binding material or agent for maintaining the shape of the pellet-shaped objects.

The substantially pellet-shaped objects may be in the size range of 3-15 mm, such as 4-13 mm, such as 5-11 mm, such as 8-10 mm. The size of the pellet-shaped objects may be determined as the diameter of an enclosing sphere.

The glass fibre material in the second form may further be treated into any form used in relation with glass fibre materials, e.g. in the form of insulation panels, insulation mats, a roll of insulation material, etc.

The glass fibre material provided by the present method may contain fibres with a diameter in the range 10-25 micrometer, such as in the range 15-18 micrometer, i.e. diameters several times larger than the typically fibre diameters in commercial mineral wool fabricated from raw glass or stone, such fibres typically have diameters less than 10 micrometers, such as in the range 2-10 micrometers. It may be an advantage to provide insulation material comprising fibres of such large diameters, since a more stiff and/or rigid insulation material may be provided. A stiffer and/or more rigid insulation material may e.g. facilitate insulation panels such as self-sustaining panels and panels of sandwich construction, these types of panels may be used as building elements, such as building envelope elements or weather screens. Further, also curved or shaped panels may be provided. Existing insulation wool products with fibre diameters in the 2-10 micrometer range are not, or only badly, suited for self-sustaining and/or curved and/or shaped building elements, since such insulation wool product are too soft. It is an advantage to provide an insulation material which is stiffer and/or more rigid. The insulation material provided by the method of the present invention is equally suited for curved, self-sustaining and flat insulation products.

The glass fibre material may be extracted by heating the composite material in a substantially inactive atmosphere in a closed furnace chamber to a process temperature between 450-650° C. during a process period until substantially all the matrix material is converted into gas. The glass fibres may remain substantially intact and may, after the process period, be withdrawn from the furnace chamber.

According to a second aspect of the present invention an apparatus comprising an inlet, a treatment chamber and an outlet may be adapted for provided insulation material according to the above-mention features.

Insulation material is provided in a third aspect. The insulation material being fabricated by the method of the first aspect, and may be fabricated by means of an apparatus according to the second aspect. The insulation material may be fabricated in any appropriate form such as in a filament form, or cotton-like form, in pellets, in the form of bats, rolls, panels, etc.

These and other aspects, features and/or advantages of the invention will be apparent from and elucidated with reference to the embodiments described hereinafter.

### BRIEF DESCRIPTION OF THE DRAWINGS

Preferred embodiments of the invention will now be described in details with reference to the drawings in which:

FIG. 1 illustrates a first embodiment where glass fibres are recycled as glass fibre insulation rolls,

FIG. 2 illustrates a second embodiment where glass fibres are recycled as glass fibre insulation pellets,

FIG. 3 illustrates a mesh,

FIG. 4 illustrates an insulation panel of the sandwich type, and

FIG. 5 illustrates embodiments of insulation panels.

### DESCRIPTION OF PREFERRED EMBODIMENTS

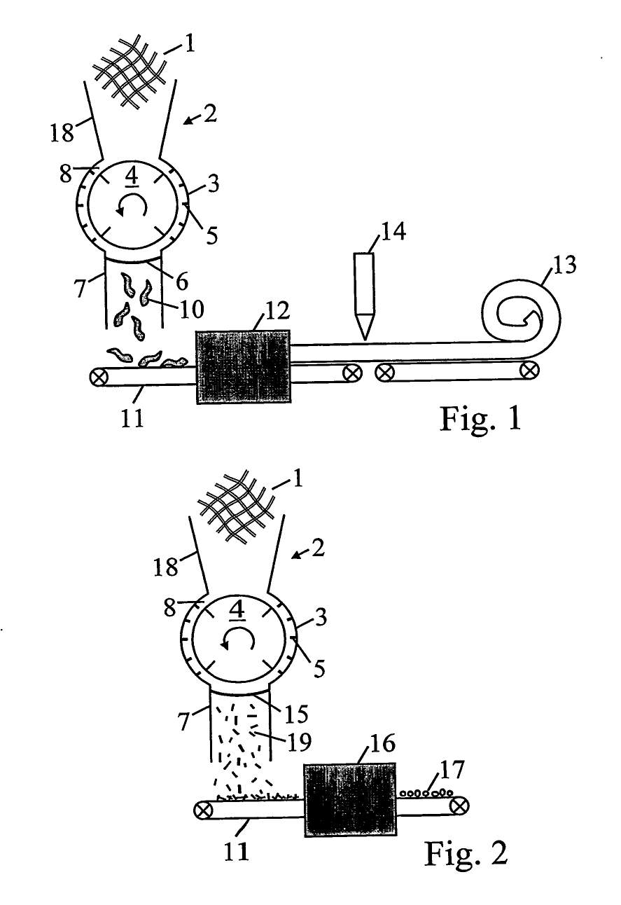

With reference to the FIGS. 1, 2 and 3 the main processes of the fabrication of insulation material are schematically illustrated.

The invention is first described in relation with the embodiment illustrated in FIG. 1. Similar features in FIGS. 1, 2 and 3 are referred to with same reference numerals.

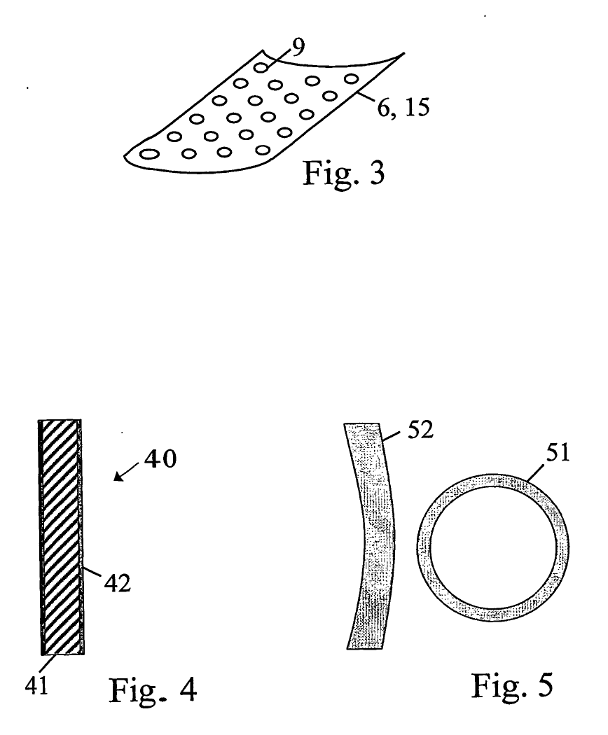

Glass fibre material 1 in a first form is fed into an apparatus 2 comprising an inlet 18 a mechanical treatment section 3 comprising a rotor 4 and a plurality of stators 5 as well as a mesh or sieve 6, the apparatus further comprises an outlet 7. The mesh or sieve is illustrated in a perspective view in FIG. 3.

The glass fibre material is mechanically treated in the mechanical treatment section from the first form and to a second form. The rotor 4 rotates at a given speed, e.g. 400 revolutions/minute, thereby forcing the glass fibre material into the gap or passage 8 between the rotor 4 and the stators 5. Due to the presence of the mesh 6 the fibre material may take more than one round in the passage 8 before it passes through the mesh resulting in that the glass fibres are cut by the stators and entangled. The mesh is carefully chosen in that the mesh openings 9 (see FIG. 3) are relatively large. Large openings result in that the fibre material only takes a few rounds in the passage 8 before it passes through the mesh openings 9. The relative large openings also ensure that the mean fibre length of the fibres 10 after passing through the mesh is relative large. With mesh openings with a size of 30 mm the mean fibre length of the individual fibres after the passage of the mesh 6 may be between 20 and 30 mm. With openings in the size range approximately between 20-50 mm, the glass fibre material after the passage of the mesh is entangle and wound up in lumps of wool-like aggregates 10 or wads.

The aggregates 10 are deposited onto a conveyor 11 and fed into an apparatus 12 where the glass fibre material is further treated to bring it from the second form and onto a third form being suitable for insulation material. In the apparatus 12 the fibre material may be coated with a binder agent, pressed and formed into a continuos roll 13 of glass fibre insulation material. The apparatus 12 may also include a furnace section for heating the insulation material, e.g. to harden the binder agent. The roll may be cut by a cutting means 14. Instead of a roll, mats, panels, etc. may be formed. Alternatively the aggregates need not be formed into a predefined shaped if e.g. the insulation material is to be used as insulation material which may be blown into a cavity, such as a cavity wall.

In FIG. 2 a second embodiment of the present invention is illustrated. Glass fibre material 1 is, as described in connection with FIG. 1, fed in a first form is into an apparatus 2 comprising an inlet 18 a mechanical treatment section 3 comprising a rotor 4 and a plurality of stators 5 as well as a mesh or sieve 15. In this embodiment, however, the mesh openings 9 are smaller than the mesh openings described in connection with FIG. 1. Small openings result in that the fibre material may take several rounds in the passage 8 before it passes through the mesh openings 9. The small openings ensure that the mean fibre length of the fibres 19 after passing through the mesh is small. With mesh openings with a size of 3 mm the mean fibre length of the individual fibres after the passage of the mesh 15 may be between 2 and 3 mm. With openings in the size range approximately between 1-10 mm, the glass fibre material after the passage of the mesh is in the form of single fibres 14 or small aggregates of fibres.

The fibres 19 are deposited onto a conveyor and fed into an apparatus 16 where the glass fibre material is further treated to bring it from the second form and onto a third form being suitable for Insulation material. The second and third forms in this embodiment being different from those described in connection with FIG. 1. The fibres may already on the conveyor start to bind together in aggregates. In the apparatus 16 the fibre material may be coated with a binder agent at the same time or in connection with stirring of the fibres resulting in that the glass fibres bind together in small pellet-shaped objects 17 or aggregates. The pellet-shaped objects may additionally be heated in a furnace section of the apparatus 16. The pellets may be used in connection with sound insulation in exhaust silencers, blown into cavity walls, etc.

In FIGS. 4 and 5 are embodiments of insulation panels illustrated. The process of transforming glass fibre material in a first form to an insulation product is illustrated in FIG. 1 and 2. However, in the FIGS. 1 and 2 the insulation products are Insulation mats and pellets, other types of insulation products may also be provided by the present invention. The apparatus as designated 12 in FIGS. 1 and 16 in FIG. 2 may be viewed as a black-box apparatus where the glass fibre material is transformed from the second form to the third form by an appropriate apparatus in a number of steps. For example, as illustrated in FIG. 4 may sandwich panels 40 comprising a middle part 41 of insulation material and two surface parts 42 of a carrier material be provided. The carrier material may be adapted for the intended end product, for example the carrier material may be a metal sheet, a plastic sheet, a gypsum sheet, it may be a net or in any other appropriate form. The insulation material may be provided in a rigid form, so that the panels may be self-sustaining. The surface sheets 42 are typically glued to the insulation material 41. Such panels may be used as building elements, such as building envelope elements or weather screens, e.g. as a labour saving material for building storage buildings, factory halls, etc. The panels may be provided such as in 1×2-metre panels, with a width of the insulation material of 100-200 mm and 0.5 to 1 mm thick surface sheets. However, any appropriate size may be provided.

Two different embodiments of curved insulation panels are illustrated in FIG. 5. Due to the use of glass fibres with large diameters, a stiffer and/or more rigid insulation material results. Curved panels 52 or even round panels 51 may, in combination with an appropriate binder agent, be provided. The curved shape may be imposed to the insulation material in a drying process by used of appropriately formed moulds. The curved panels may also be provided with a surface cladding, e.g. a plastic cladding. The curvature may be chosen in accordance with a desired product. The radius of curvature may be between a few centimetres up to several metres. Different shapes than those illustrated here may also be envisioned, such as angle-shapes, U-shapes, etc.

In the embodiments described in connection with FIGS. 1 and 2 the glass fibre material in the first form 1, is in the form of a fabric. In e.g. wind turbine blades, the blades may be reinforced by incorporating a glass fibre fabric into the matrix material. However, a particular form of the fibre material in the first form is not important, other forms may be used, e.g. roving bundles, chopped strand mats, etc. It may be necessary that the mean fibre length of the fibres in the first form is longer than the desired mean fibre length of the glass fibre material in the third form.

As a particular example the glass fibre material in the first form may be extracted in a pyrolysis process, where the glass fibre material is extracted in the first form from e.g. a wind turbine blade by means of pyrolysis of the matrix material of the wind turbine blade. The wind turbine blade may be introduced into a furnace of a recycling plant adapted to extract glass fibre material from blades. The furnace may be heated in an inactive atmosphere to the pyrolysis temperature which is in the order of 450-650° C., the temperature may depend upon the matrix material. It may be an advantage to expose the glass fibre material to as low a temperature as possible, since the tensile strength of the glass fibre material after the pyrolysis process may be higher if a low pyrolysis temperature is used.

In the pyrolysis process the matrix material of the glass fibre blade is decomposed into volatile gases and degradation of the blade takes place. After final pyrolysis of the blade, the fibre reinforcement is left on e.g. a grid tray as a loose layer that may be scraped out and further processed in connection with the present invention.

The mechanical treatment section may alternatively be envisioned differently. An important feature of the mechanical treatment section may be that it is capable of separating the fibres and cut them into the desired length. Entangling of the fibres may be achieved at a later stage, e.g. by introducing an entanglement section between the outlet and the conveyor.

Although the present invention has been described in connection with preferred embodiments, it is not intended to be limited to the specific form set forth herein. Rather, the scope of the present invention is limited only by the accompanying claims.

Variations in the process, the apparatus and the products, depending on the exact nature of the glass fibre material in the first form and the different forms of insulation materials which are fabricated are considered to lie within the capacity of a person skilled in the art and thus to be covered by the protection.

1. A method of recycling glass fiber material, the method comprising:
providing glass fiber material extracted from a composite material containing glass fiber embedded in a matrix material, the glass fiber material being provided in a first form;
mechanically treating the glass fiber material in the first form so as to generate glass fiber material in a second form, the glass fibers in the second form having a mean fiber length smaller than the mean fiber length of the glass fibers in the first form; and
treating the glass fiber material in the second form so as to generate glass fiber material in a third form, the glass fiber material in the third form being suitable for insulation material, wherein the material in the third form comprises glass fibers in a form where the fibers are in a random, or apparently random, network comprising cavities.

2. A method according to claim 1, wherein the glass fibers in the first form have a mean fiber length such that the first form is a non-powder form.

3. A method according to claim 1, further comprising extracting the material in the first form from the matrix material with pyrolysis or gasification of the matrix material. fiber fiber.

4. A method according to claim 1, further comprising extracting the material in the first form from the matrix material by incineration or oxygen combustion of the matrix material. fiber fiber.

5. A method according to to claim 1, further comprising extracting the material in the first form from the matrix material by chemically dissolving the matrix material. fiber fiber.

6. A method according to claim 1, wherein the composite material is substantially a waste material.

7. A method according to claim 1, wherein an amount of mineral wool is added to the glass fiber in the first form.

8. A method according to claim 1, wherein mechanically treating the glass fiber material in the first form comprises passing the glass fiber material from an inlet through a chamber comprising a rotor and a plurality of stators and from the chamber through a mesh into an outlet.

9. A method according to claim 8, wherein the mesh comprises mesh openings in the size range of at least one of from about 1 mm to about 10 mm, from about 2 mm to about 8 mm, and from about 3 mm to about 5 mm.

10. A method according to claim 8, wherein the mesh comprises mesh openings in the size range of at least one of at least one of from about 20 mm to about 50 mm, from about 25 mm to about 45 mm, from about 30 mm to about 40 mm, and about 35 mm.

11. A method according to claim 1, wherein the glass fiber material in the second form comprises glass fibers having a mean fiber length in the range of at least one of about from about 0.1 mm to about 5 mm, from about 0.5 mm to about 5 mm, from about 1 mm to about 4 mm, and from about 2 mm to about 3 mm.

12. A method according to claim 1, wherein the glass fiber material in the second form comprises glass fibers having a mean fiber length in the range of at least one of from about 10 mm to about 40 mm, from about 15 mm to about 35 mm, from about 20 mm to about 30 mm, and about 25 mm.

13. A method according to claim 1, wherein the glass fiber material in the first form comprises glass fibers having a mean fiber diameter in the range of at least one of from about 10 micrometers to about 25 micrometers, and from about 15 micrometers to about 18 micrometers.

14. A method according to claim 1 wherein treating the glass fiber material in the second form comprises generating glass wool. fiber.

15. A method according to claim 11, wherein treating the glass fiber material in the second form comprises generating substantially pellet-shaped objects comprising glass fiber. fiber fiber.

16. A method according to claim 15, wherein the substantially pellet-shaped objects are in the size range of at least one of from about 3 mm to about 15 mm, from about 4 mm to about 13 mm, from about 5 mm to about 11 mm and from about 8 mm to about 10 mm.

17. A method according to claim 1, wherein treating the glass fiber material in the second form comprises generating fiber insulation panels, insulation mats or a roll of insulation material.

18. A method according to claim 17, wherein the insulation panel comprises at least one curved surface.

19. A method according to claim 1, further comprising extracting the material in the first form from the matrix material fiber by heating the composite material in a substantially inactive atmosphere in a closed furnace chamber to a process temperature between 450-650° C., wherein substantially all of the matrix material is converted into a gas, by removing the gas, wherein the glass fibers remain substantially intact, and withdrawing the glass fibers from the furnace chamber.

20. A method according to claim 1, wherein the matrix material comprises at least one of a thermosetting resin, an epoxy material, a polyester resin, a vinylesther resin, a phenoplast resin, and thermoplastic material.

21. A method according to claim 1, wherein the material in the third form is suitable for at least one of heat insulation, cold insulation, and sound insulation.

22. An apparatus comprising.
an inlet,
a treatment chamber connected to the inlet; and
an outlet connected to the treatment chamber,
wherein the apparatus is configured to perform the method according to claim 1.

23. Insulation material fabricated according to the method of claim 1.

24. A method of using glass fiber, the method comprising: fiber
providing the glass fiber material, the glass fiber material having been extracted from a composite material containing glass fiber embedded in a matrix material; and
placing the glass fiber material between first and second locations, wherein the glass fiber material is configured to insulate the first location from the second location.

25. A method according to claim 15, wherein the pellet-shaped objects further comprise a binding material configured to substantially maintain the shape of the pellet-shaped objects.
